(19) United States
(12) Patent Application Publication
(10) Pub. No.: US 2026/0007155 A1
(43) Pub. Date: Jan. 8, 2026

(54) COMPOSITION FOR REMOVING THE BURNING AND BITTERNESS DURING CONSUMPTION OF ETHANOL BASED BEVERAGES

(71) Applicant: Alco-Ease LLC, New York, NY (US)

(72) Inventor: Quang Bui, New York, NY (US)

(21) Appl. No.: 18/765,055

(22) Filed: Jul. 5, 2024

(51) Int. Cl. A23L 27/40; C12G 3/06

(52) U.S. Cl. CPC A23L 27/40; C12G 3/06

(57) ABSTRACT

A composition for reducing the burning effect and bitter taste experienced during consumption of ethanol-based beverages comprised of sodium bicarbonate, sodium chloride and honey.

### BACKGROUND

### Field of the Invention

The invention relates generally to ingestible compositions, and more specifically, to ingestible compositions for removing the burning and bitterness experienced during the consumption of ethanol-based beverages.

### Related Art

Ethanol-based beverages such as beer, wine and liquor are produced by fermentation of various food products such as, for example, grains, fruits or vegetables. Many types of ethanol-based beverages produce a burning sensation as they travel down the throat during consumption and/or a bitter flavor that dominates the palate. In an attempt to reduce these effects, and sometimes to improve the flavor of the beverage, ethanol-based beverages are paired with one or more non ethanol-based beverages, also known as “chasers.” Many chasers contain high levels of sugar and calories, contributing to weight gain and potential health issues such as diabetes or dental problems when consumed in excess. Additionally, the combination of alcohol and sugary chasers can intensify hangover symptoms.

Disclosed is a composition that, when added to an ethanol-based beverage, reduces the burning effect and bitter taste experienced during consumption of the ethanol-based beverage, without the inclusion of substantial calories or sugars and without adding any flavor or taste to the ethanol-based beverage. The composition also reduces effects of heartburn and indigestion.

### SUMMARY OF THE INVENTION

It is to be understood that the phraseology and terminology employed herein are for the purpose of the description and should not be regarded as limiting.

Disclosed is a composition for removing the burning effect and bitter taste experienced during consumption of ethanol-based beverages, the composition comprising sodium bicarbonate, sodium chloride, and honey. These and other features will become readily apparent upon further review of the specification and claims.

### DETAILED DESCRIPTION

Disclosed is a composition for removing the burning effect and bitter taste experienced during consumption of ethanol-based beverages, the composition comprising sodium bicarbonate, sodium chloride, and honey. Any type of honey may be used although certain types of honey may be used to provide certain health benefits. For example, Manuka honey is known for its antibacterial, antioxidant, and anti-inflammatory properties and may be used to reduce any inflammation caused by the consumption of an ethanol-based beverage.

In certain embodiments, the composition exists in a powder form. During the manufacture of these embodiments, the honey may be incorporated into the composition in a dehydrated form and mixed well with the sodium bicarbonate and the sodium chloride which may be incorporated into the composition in a fine powdered form.

The composition may also be manufactured as a liquid, super saturated liquid, solid or semi-solid. To manufacture the composition as a liquid, the sodium bicarbonate, sodium chloride, and honey may be completely dissolved into a liquid solvent such as distilled water. To manufacture the composition as a solid or semi-solid, a binding agent may be mixed with the sodium bicarbonate, sodium chloride, and honey to create a paste. A wet binding agent is preferably used but a dry binding agent may also be used. The resulting paste is then added to a manual or automatic pill press. Other conventional methods of creating pills, solid or semi-solid compositions may be used.

In embodiments of the invention, the composition is manufactured by combining 1000-1500 mg of powdered sodium bicarbonate, 50-200 mg of finely ground sodium chloride, and 500-800 mg of dehydrated honey. Another benefit of the disclosed composition is that it does not add any flavor to the ethanol-based beverage. The quantities may be equally scaled to create a greater amount of the composition. Diverging from the ratios disclosed above would affect the effectiveness of the composition. For example, using more sodium bicarbonate alone would add an unwanted taste to the beverage. Adding more sodium chloride alone would produce a “salty” taste in the beverage. The honey serves to balance the salt, however, adding more honey alone would add a sweet flavor to the beverage.

The composition completely dissolves upon mixture into an ethanol-based beverage. In use, preferably 2 g of the composition is used for 1.5 ounces of a liquid ethanol-based beverage. A non ethanol-based beverage may also be added to fill an 8 ounce glass. By way of example only, 2 g of the composition may be added to a beverage containing 1.5 ounces of vodka and 6.5 ounces of club soda. 2 g of the composition maintains its effectiveness in up to 3 ounces of an ethanol-based beverage.

In embodiments, the composition may further include one or more types of dehydrated beverage.

This disclosure is not intended to limit the invention to the particular composition disclosed, but, to the contrary, the intention is to cover all modifications, equivalents, and alternatives falling within the scope of the claims.

What is claimed is:

1. A composition for reducing the burning effect and bitter taste experienced during consumption of ethanol-based beverages, comprising:
a. sodium bicarbonate
b. sodium chloride; and
c. honey.

2. The composition of claim 1, wherein the composition is a powder.

3. The composition of claim 1, comprising 1300 mg of sodium bicarbonate.

4. The composition of claim 1, comprising 50 mg of sodium chloride.

5. The composition of claim 1, comprising 550 mg of honey.

6. A method for altering the taste of ethanol-based beverages comprising the steps of:
a. combining the composition of claim 1 with an ethanol-based beverage; and
b. mixing to result in a homogeneous liquid.

7. A powder composition for reducing the burning effect and bitter taste experienced during consumption of ethanol-based beverages, comprising:
a. One or more types of dehydrated drink
b. sodium bicarbonate
c. sodium chloride; and
d. honey.
